(19) United States
(12) Patent Application Publication
(10) Pub. No.: US 2007/0140275 A1
(43) Pub. Date: Jun. 21, 2007

(54) Method of preventing denial of service attacks in a cellular network

(76) Inventors: Chris Bowman, Round Rock, TX (US); Frank Sheiness, Austin, TX (US); David W. Daugherty, Austin, TX (US)

Correspondence Address: ANTHONY EDW. J CAMPBELL, PO BOX 160370, AUSTIN, TX, 78716, US

(21) Appl. No.: 11/639,843

(22) Filed: Dec. 15, 2006

Related U.S. Application Data
(60) Provisional application No. 60/752,768, filed on Dec. 21, 2005.

(51) Int. Cl. H04L 12/56

(52) U.S. Cl. 370/401; 370/428

(57) ABSTRACT

A system, method, and computer readable medium for preventing denial of service attacks in a cellular network, that comprises, counting a data packet generated by an address on the cellular network and blocking access to the cellular network of the address if the counted data packets exceeds a pre-defined threshold.

### PRIORITY

This application is based in part upon provisional application 60/752,768, filed Dec. 21, 2005, and claims filing date priority based upon that application.

### BACKGROUND OF THE INVENTION

The present invention is generally related to security in a cellular network and, more specifically to a method of preventing denial of service attacks in a cellular network.

The distinction between computers, personal digital assistants and cell phones has been blurring with internet services migrating toward portable handheld devices. The benefit of availability of service comes with an increased risk of intrusion and attack. A Denial of Service (DoS) brute force attack is one in which a device connected to a cellular network consumes large portions of the cellular network bandwidth. Brute force attacks performed via virus infection on cellular telephones is an increasing threat. Currently, cellular network security performs intrusion prevention and detection technology at the layer 3-4 level. These devices can stop data packets from exiting or entering a cellular network but do nothing to stopped forced flooding of a cellular network from within the network.

Therefore, what is needed is a method of preventing denial of service attacks in a cellular network. More specifically, what is needed is a method of preventing denial of service attacks in a cellular network that operates at layer 2. The present invention provides the ability to automatically detect, and then block a cellular network connection from a malicious device via layer 2 monitoring and access control list.

The present invention utilizes a computer program which monitors how many data packets per second are coming from each Cellular IDentification (Cell ID) address and/or Media Access Control (MAC) address on the cellular network. If one cellular identification address and/or media access control address exceeds a pre-determined threshold, in this instance of 2000 data packets per second counted, then the computer program will automatically execute a layer 2 command which will cause an Address Resolution Protocol (ARP) request from the malicious device to go unanswered for a pre-set time interval such as 10 minutes. During this time the device will not be able to relocate its gateway, effectively blocking it from the cellular network. There are no other known methods that can identify and isolate a denial of service attack at layer 2.

The current invention uses a pre-determined threshold of data packet transmission of 2000 data packets per second counted to identify and then isolate offending devices. Other embodiments of the invention may use the number of devices on the cellular network, the total bandwidth on the cellular network and the type applications being used on the device to set the threshold.

In the present invention the computer program identifies any new cellular identification address and/or media access control address received via ARP. After each cellular identification address and/or media access control address is identified another computer program calculates the number of data packets per second transferred by each cellular identification address and/or media access control address. If a device exceeds a preset threshold of 2000 data packets per second then the offending devices cellular identification address and/or media access control address is blocked which in turn terminates all activity from the offending device.

Advantages of controlling malicious devices at Layer 2 include the ability to control attacks from within the cellular network, and the reduction of capital cost associated with the elimination of Layer 3 and higher network equipment required to prevent attacks from outside the cellular network. Without this invention, one device on a cellular network could effectively consume the entire bandwidth of the cellular network slowing all other devices to a crawl by of brute force network attacks or excessive port scanning.

The present invention is a virtual or Internet-based set-top box for the acquisition and management of Internet services and content delivered through the cellular network. This system is comprised of network appliances that are connected to the cellular network infrastructure to assert controls necessary to establish and maintain consistent, standard cellular network services for users. The service management console is a web-based system that provides the end-user controls required to configure and control Internet services and content delivered to all sites. Each geographically remote site is configured with a network appliance and is managed by a web-resident, centralized control system that provides various levels of administrative service depending upon the administrator.

This system allows end users to select any combination of content, and communication services provided by service providers. The present invention utilizes a cellular identification address and/or media access control address based means of controlling communications services within a cellular network. This system allows service providers to deploy internet services to end customer based on a cellular identification address and/or media access control addresses collected by the system or provided by the customer. The system allows the service provider and customer access to network provision controls for a specific to a specific cellular identification address and/or media access control address.

The present invention utilizes the cellular ID-based means of controlling cellular network quality of service. This includes the ability to automatically detect various types of security threads based on data packet signature and the subsequent adjustment services. Adjustment can include the following automated or manual changes, termination of service, customer isolation or quarantining and the notification of management and technical personnel.

The present invention utilizes an internet-based means of identification and authenticating Internet service customers. This system includes the ability to identify customers by their cellular identification address and/or media access control addresses, identification of communication appliances using appliance specific electronic identification information. This system is used to authenticate customers or communication appliances for the use of cellular communication services and/or access to Internet based content.

A cellular ID-based means of controlling network Denial of Service (DoS) attacks. From a technical perspective, problems arise when a user starts flooding any destination on the Internet; a flood could be a port scan, high rate of Internet Control Message Protocol (ICMP) or pings, User Datagram Protocol (UDP) floods. This system allows the service provider to define ICMP, UDP and Transmission Control Protocol (TCP) packet limits to control this type of traffic. Default ranges are typically set for UDP at 150 Packets Per Second (PPS), TCP at 200 PPS, and ICMP at 50 PPS.

This system provide the information to facilitate the identification and management and isolation of devices that begin making abnormal Internet service requests before they have an opportunity to impact cellular network performance. The system restricts certain kinds of traffic based on predefined thresholds. In severe cases, the system will redirect compromised devices to a quarantine area where utilities are available for discovering and correcting the problem before restoring access to the Internet.

Assuming the network engineer can monitor Layer 2 switch ports, he/she would have to find out what switch port the offending device resides on (switch or router) and then issue an instruction to the switch to disconnect the port electronically. In this invention offending devices are automatically identified and isolated by utilizing computer programs at the layer 2 level.

An alternative version of the invention utilizes counting data packets per second at the protocol level instead of layer 2, or a combination of both layer 1 and layer 2. This method would involve developing scripts to monitor popular protocols, UDP, TCP, and ICMP. We would put defined limits on each protocol, UDP, for example, might be limited to a maximum of 500 data packets per second, TCP might be limited to 200 data packets per second, and ICMP 50 data packets per second. This would provide more granular control over what should be blocked. If, for example, an offending device was flooding the cellular network with UDP traffic, we could shut down the UDP connections without affecting TCP and ICMP traffic. This invention provides a more consistent and safe network for devices residing on a cellular network and automatically alerts network engineers about problem causing devices. Thus eliminates a time consuming, tedious task of locating and isolated problem devices.

In one embodiment of the present invention, a method for preventing denial of service attacks in a cellular network, that comprises, counting a data packet generated by an address on the cellular network and blocking access to the cellular network of the address if the counted data packets exceeds a pre-defined threshold. Where the counting is performed per time unit, the blocking is active for a pre-set interval, the address is at least one of a cellular identification address and a media access control address and the counting is performed at layer 2 or layer 1. The method may comprise disabling the address, identifying the address upon connection to the cellular network, defining the threshold based upon a number of devices utilizing the cellular network, defining the threshold, based upon a bandwidth of the cellular network, disinfecting the address exceeding the pre-defined threshold.

In a further embodiment of the present invention, a computer readable medium that comprises instructions for identifying at least one of a cellular identification address and a media access control address upon connection to a cellular network, counting a data packet generated per unit time by at least one of the cellular identification address and the media access control address on the cellular network and blocking access of at least one of the cellular identification address and the media access control address to the cellular network if the counted data packets exceeds a pre-defined threshold. Where the blocking is active for a pre-set interval, the counting is performed at layer 2 or layer 1. The computer readable medium may comprise instructions for disabling at least one of the cellular identification address and the media access control address, defining the threshold based upon the number of devices utilizing the cellular network and the bandwidth of the cellular network and disinfecting at least one of the cellular identification address and the media access control address exceeding the pre-defined threshold.

In yet a further embodiment, a system adapted to provide preventing denial of service attacks in a cellular network that comprises a memory and a processor communicably coupled to the memory, the processor communicably coupled to the cellular network, the processor is adapted to identify at least one of a cellular identification address and a media access control address upon connection to the cellular network and count a data packet generated per unit time by at least one of the cellular identification address and the media access control address on the cellular network and block access of at least one of the cellular identification address and the media access control address to the cellular network if the counted data packets exceeds a pre-defined threshold, wherein the blocking is active for a pre-set interval. The system may include disinfecting at least one of the cellular identification address and the media access control address exceeding the pre-defined threshold.

### BRIEF DESCRIPTION OF THE DRAWINGS

FIG. 1 depicts a method of preventing denial of service attacks in a cellular network system in accordance with a preferred embodiment of the present invention; and

FIG. 2 depicts a software flow block in accordance with a preferred embodiment of the present invention.

### DETAILED DESCRIPTION OF THE INVENTION

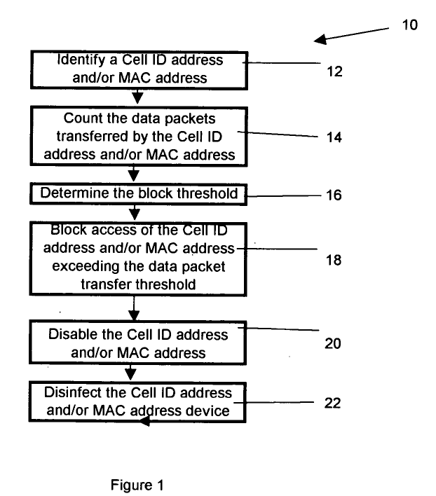

Referring now to FIG. 1, a method for preventing denial of service attacks in a cellular network 10 is shown. The invention comprises identifying 12 an address, typically at least one of a cellular identification address and a media access control address. A number of data packets transferred by the address is counted 14. A threshold of denial of service is determined 16. If the number of data packets transferred exceeds the threshold, access to the network is blocked 18. If the number of data packets transferred exceeds the threshold at least one of the cellular identification address and the media access control address is disabled 20 and a device associated with at least one of the cellular identification address and the media access control address is disinfected. In other embodiments, the counting may per performed per time unit, the blocking may be active for the pre-set interval, the address may be disabled, the address may be the cellular identification address, the address may be a media access control address, the counting could be performed at layer 2 or layer 1, the address may be identified upon connection to the network, the threshold may be based upon the number of users utilizing the network, the defined threshold may be based upon a bandwidth of the network and the disinfecting may be done of the address exceeding the pre-defined threshold. The steps performed in this figure are performed by software, hardware, firmware, and/or the combination of software, hardware, and/or firmware. The transfer of information between the network and processor occurs via at least one of the wireless protocol, the wired protocol and the combination of the wireless protocol and the wired protocol.

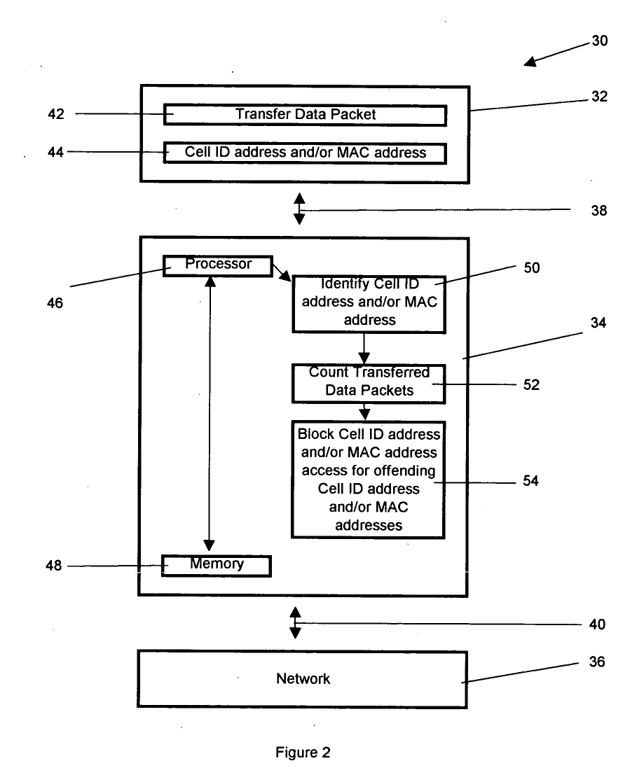

Referring now to FIG. 2 a system for preventing denial of service attacks in the network 30 is depicted and comprises the number of blocks or modules that are software, hardware, firmware, and/or the combination of software, hardware, and/or firmware. The system is adapted to provide preventing denial of service attacks in the network 36, comprising a memory 48, a processor 46 communicably coupled to the memory, the processor is communicably coupled 40 to the network 36. The processor is adapted to identify 50 at least one of the cellular identification address and the media access control address upon connection to the network, count 52 the data packet generated per unit time by at least one of the cellular identification address and the media access control address on the network and block 54 access of at least one of the cellular identification address and the media access control address to the network if the counted data packets exceeds the pre-defined threshold, wherein the blocking is active for the pre-set interval. In other embodiments the invention may comprise disinfecting at least one of the cellular identification address and the media access control address exceeding the pre-defined threshold. For example, the presence infrastructure may be accessed by the cellular phone or the computer with external wireless capability (such as the wireless card) or internal wireless capability (such as 802.11 or any of the other 802 variants), or by the Internet Protocol enabled phone. The communications coupling occurs via at least one of the wireless protocol, the wired protocol and the combination of the wireless protocol and the wired protocol.

Although the exemplary embodiment of the system of the present invention has been illustrated in the accompanied drawings and described in the foregoing detailed computer program, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the processor, memory and network. Also, these capabilities may be performed in the current manner or in the distributed manner and on, or via, any device able to provide and/or receive internet content. Further, although depicted in the particular manner, various modules or blocks may be repositioned without departing from the scope of the current invention. For example, the functionality performed by the processor and memory may be self contained. Still further, although depicted in the particular manner, the greater or lesser number of data packets, cellular identification addresses, media access control addresses, processors, memories and networks can be utilized with the present invention. Further, the lesser or greater number of data packets may be utilized with the present invention and such data packets may include known complementary information in order to accomplish the present invention, to provide additional known features to the present invention, and/or to make the present invention more efficient.

What is claimed is:

1. A method for preventing denial of service attacks in a cellular network, comprising:
counting a data packet generated by an address on the cellular network; and
blocking access to the cellular network of the address if the counted data packets exceeds a pre-defined threshold.

2. The method of claim 1 wherein the counting is performed per time unit.

3. The method of claim 1 wherein the blocking is active for a pre-set interval.

4. The method of claim 1 comprising disabling the address.

5. The method of claim 1 wherein the address is at least one of:
a cellular identification address; and
a media access control address.

6. The method of claim 1 wherein the counting is performed at layer 2.

7. The method of claim 1 wherein the counting is performed at layer 1.

8. The method of claim 1 comprising identifying the address upon connection to the cellular network.

9. The method of claim 1 comprising defining the threshold based upon a number of devices utilizing the cellular network.

10. The method of claim 1 comprising defining the threshold based upon a bandwidth of the cellular network.

11. The method of claim 1 comprising disinfecting the address exceeding the pre-defined threshold.

12. A computer readable medium comprising instructions for:
identifying at least one of a cellular identification address and a media access control address upon connection to a cellular network;
counting a data packet generated per unit time by the at least one of the cellular identification address and the media access control address on the cellular network; and
blocking access of the at least one of the cellular identification address and the media access control address to the cellular network if the counted data packets exceeds a pre-defined threshold.

13. The computer readable medium of claim 12 wherein the blocking is active for a pre-set interval.

14. The computer readable medium of claim 12 comprising instructions for disabling the at least one the of the cellular identification address and the media access control address.

15. The computer readable medium of claim 12 wherein the counting is performed at layer 2.

16. The computer readable medium of claim 12 wherein the counting is performed at layer 1.

17. The computer readable medium of claim 12 comprising instructions for defining the threshold based upon the number of devices utilizing the cellular network and the bandwidth of the cellular network.

18. The computer readable medium of claim 12 comprising disinfecting the at least one of the cellular identification address and the media access control address exceeding the pre-defined threshold.

19. A system adapted to provide preventing denial of service attacks in a cellular network, comprising:
a memory; and
a processor communicably coupled to the memory, the processor communicably coupled to the cellular network, the processor adapted to:
identify at least one of a cellular identification address and a media access control address upon connection to the cellular network;
count a data packet generated per unit time by the at least one of the cellular identification address and the media access control address on the cellular network; and
block access of the at least one of the cellular identification address and the media access control address to the cellular network if the counted data packets exceeds a pre-defined threshold, wherein the blocking is active for a pre-set interval.

20. The system of claim 19 comprising disinfecting the at least one of the cellular identification address and the media access control address exceeding the pre-defined threshold.
